(19) United States
(12) Patent Application Publication
(10) Pub. No.: US 2021/0150243 A1
(43) Pub. Date: May 20, 2021

(54) EFFICIENT IMAGE SHARING

(71) Applicant: BANMA ZHIXING NETWORK (HONGKONG) CO., LIMITED, Kowloon (HK)

(72) Inventor: Zhenghua Wang, Shanghai (CN)

(21) Appl. No.: 17/108,996

(22) Filed: Dec. 1, 2020

Related U.S. Application Data
(63) Continuation-in-part of application No. PCT/CN19/89772, filed on Jun. 3, 2019.

(30) Foreign Application Priority Data
Jun. 7, 2018 (CN) 201810581577.4

(51) Int. Cl. G06K 9/20; G06K 9/78; G06K 9/62; G06F 3/0488; G06F 3/0484; H04L 12/58; G06N 5/04; G06N 20/00; G06F 16/55; G06F 9/445

(52) U.S. Cl. CPC G06K 9/2081; G06K 9/78; G06K 9/6277; G06F 3/0488; G06K 9/6217; G06F 9/445; H04L 51/046; G06N 5/04; G06N 20/00; G06F 16/55; G06F 3/04845

(57) ABSTRACT

Embodiments of efficient image sharing is disclosed, including: obtaining image data; obtaining classification information corresponding to the image data; determining sharing operation information corresponding to the image data based at least in part on the classification information; invoking a program corresponding to the sharing operation information corresponding to the image data; and sharing the image data using the program.

### CROSS REFERENCE TO OTHER APPLICATIONS

This application is a continuation-in-part of and claims priority to International (PCT) Application No. PCT/CN19/89772, entitled DATA PROCESSING METHOD AND APPARATUS, ELECTRONIC DEVICE AND READABLE MEDIUM filed on Jun. 3, 2019, which is incorporated herein by reference in its entirety for all purposes, which claims priority to China Patent Application No. 201810581577.4, entitled A DATA PROCESSING METHOD AND MEANS, AN ELECTRONIC DEVICE AND A READABLE MEDIUM filed on Jun. 7, 2018 which is incorporated by reference in its entirety for all purposes.

### FIELD OF THE INVENTION

The present application relates to a field of computer technology. In particular, the present application relates to techniques for recommending a sharing operation based on user selected image data.

### BACKGROUND OF THE INVENTION

As terminal technology develops, more and more users are using terminal devices to execute necessary operations. Examples of such operations include querying for information via browsers, sharing and exchanging information through social media software, and communicating with instant messaging software.

While browsing, users sometimes come across interesting information such as a picture and may then save it to their terminals. Then, users may open an application software to share the saved information. For example, a user may send the saved information to a friend in a communication program or the user may use the saved information to search for corresponding products in a shopping program.

However, this kind of sharing often requires the users to manually determine which program to use to perform the sharing. For example, after closing the current program (e.g., in which they had found the interesting information), a user must then open the program that is needed for sharing. Or, to give another example, the user may select a sharing option in the current program or perform a look-up in a sharing program. This is a relatively inefficient way to share information.

### SUMMARY OF THE INVENTION

The present application discloses techniques comprising:

obtaining image data;

obtaining classification information corresponding to the image data;

determining sharing operation information corresponding to the image data based at least in part on the classification information;

invoking a program corresponding to the sharing operation information corresponding to the image data; and

sharing the image data using the program.

### BRIEF DESCRIPTION OF THE DRAWINGS

Various embodiments of the invention are disclosed in the following detailed description and the accompanying drawings.

FIG. 1 is a diagram showing a diagram of an embodiment of a process for efficient image sharing.

FIG. 2 is a diagram showing an example of efficient image sharing at a terminal device in accordance with some embodiments.

FIG. 3 is a diagram showing another example of efficient image sharing at a terminal device in accordance with some embodiments.

FIG. 4 is a diagram showing an embodiment of a system for efficient image sharing.

FIG. 5 is a diagram showing an example of a classifier in accordance with some embodiments.

FIG. 6 is a diagram showing an example process of using a data analyzer in accordance with some embodiments.

FIG. 7 is a diagram showing an embodiment of a process for efficient image sharing.

FIG. 8 is a diagram showing an example of a process for efficient image sharing in accordance with some embodiments.

FIG. 9 is a diagram showing an example of an operating system for efficient image sharing in a terminal device.

FIG. 10 is a diagram showing an example of a system for efficient image sharing in accordance with some embodiments.

FIG. 11 is a diagram showing an example of a system for efficient image sharing in accordance with some embodiments.

FIG. 12 is a hardware structural diagram of an electronic device in accordance with some embodiments.

FIG. 13 is a hardware structural diagram of an electronic device in accordance with some embodiments.

FIG. 14 is an example operating system that is executing at a terminal device in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

To make the above-described objectives, features, and advantages of the present application plainer and easier to understand, the present application is explained in further detail below in light of the drawings and specific embodiments.

Embodiments of efficient image sharing are described herein. Image data is obtained. Classification information corresponding to the image data is obtained. Sharing operation information corresponding to the image data is determined based at least in part on the image data. A program corresponding to the sharing operation information corresponding to the image data is invoked. In some embodiments, a “program” refers to a software application. The image data is shared using the program. In various embodiments, the sharing operation information includes at least a sharing operation type and identifying information associated with the program to invoke and use to perform the sharing operation type with respect to the image data. Examples of a sharing operation type include, but are not limited to, sending the image data to a contact in a communication program, posting the image data to a social media platform program, and inputting the image data into an image-based search of a search program or a shopping program. In some embodiments, “shared” image data may be jointly/concurrently used by two or more programs. For example, the image data may be used by a program and may also be presented to other users (e.g., the image data may be input into an image-based search in a shopping program and also be sent to a friend in an instant messaging program). Thus, the sharing operation for the image data can be determined automatically (e.g., without user intervention) and the image data can also be shared automatically (e.g., without user intervention). In some embodiments, execution of the sharing operation with respect to the image data is referred to as “publishing” or “publication” of the image data.

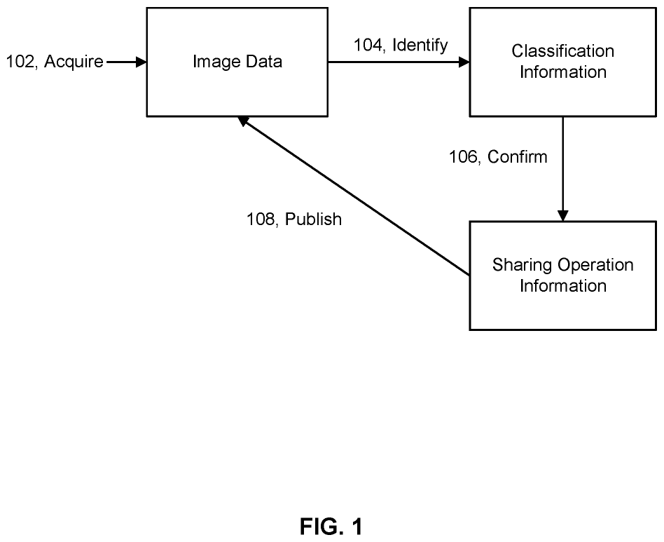

FIG. 1 is a diagram showing a diagram of an embodiment of a process for efficient image sharing.

At 102, image data may be acquired. There are multiple sources from which image data may be acquired. For example, the image data may be downloaded from the Internet, acquired locally, acquired through taking a picture, downloaded from a program, or acquired by capturing a screen image. Specifically, a screen image (e.g., a screen capture) may be obtained at a terminal device as follows: while using a terminal device, if a user is interested in content displayed by the terminal device, he or she may issue instruction information through an operation associated with screen captures and then the terminal device is configured to capture the screen image to obtain corresponding image data, e.g., capture an image of the entire screen or an image of a part of the screen. For example, the screen capture instruction information may be triggered according to at least one of the following operations: tap operation, gesture operation, and swipe operation. A tap operation may be generated by a user tapping or double-tapping the screen. A gesture operation may be generated by a user performing a predetermined gesture within a predetermined proximity to or using the terminal device. Examples of a gesture operation include shaking the device or performing a gesture on the screen. A swipe operation may be generated by a user swiping on the screen, such as, for example, swiping around an area to capture a screen image.

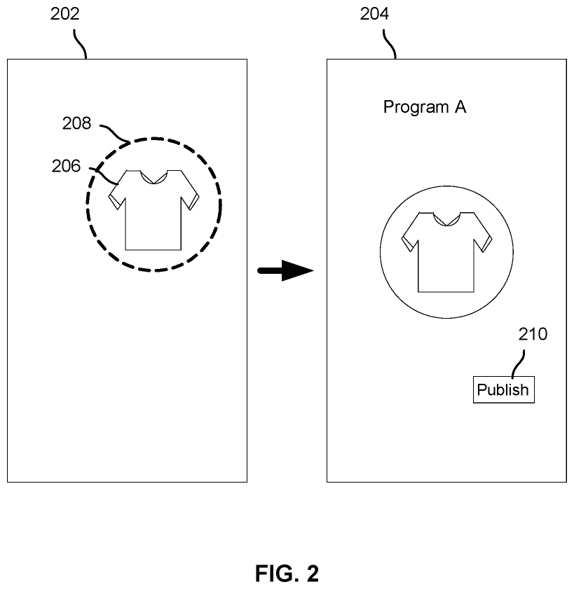

The following is a specific example of using a swipe operation to capture a screen image that is performed at the terminal device: determining the capture area according to a user operation (e.g., in which a user swipes a shape over at least a portion of the content that is displayed at the display screen of the terminal device) and capturing the screen image corresponding to the capture area. For example, area coordinate information may be determined according to the user operation. Or, to give another example, an area's coordinates are determined by acquiring the center point of the area that was drawn by the user operation. A screen image is then captured of the content that is displayed within the capture area. FIG. 2 is a diagram showing an example of efficient image sharing at a terminal device in accordance with some embodiments. For example, in display screen 202 of FIG. 2, a tap location of a user tap operation may be received with respect to shirt image 206. In response to the user tap operation, the tap location may serve as the center of circular area 208. In the example of FIG. 2, circular area 208 is determined by sweeping a predetermined radius from shirt image 206, which is associated with the tap location. Then, the image data within circular area 208 is captured as a screen image. In another example, circular area 208 is drawn by a user using a swipe operation and the coordinates of circular area 208 are determined based on the swipe coordinates. Then, the image data within circular area 208 is captured as a screen image. The swipe area may be of an irregular shape, and, in some embodiments, the swipe area may then be adjusted to the corresponding area that is of a regular circular, square, triangular, or some other shape. Then the image data within the adjusted regular shape is captured.

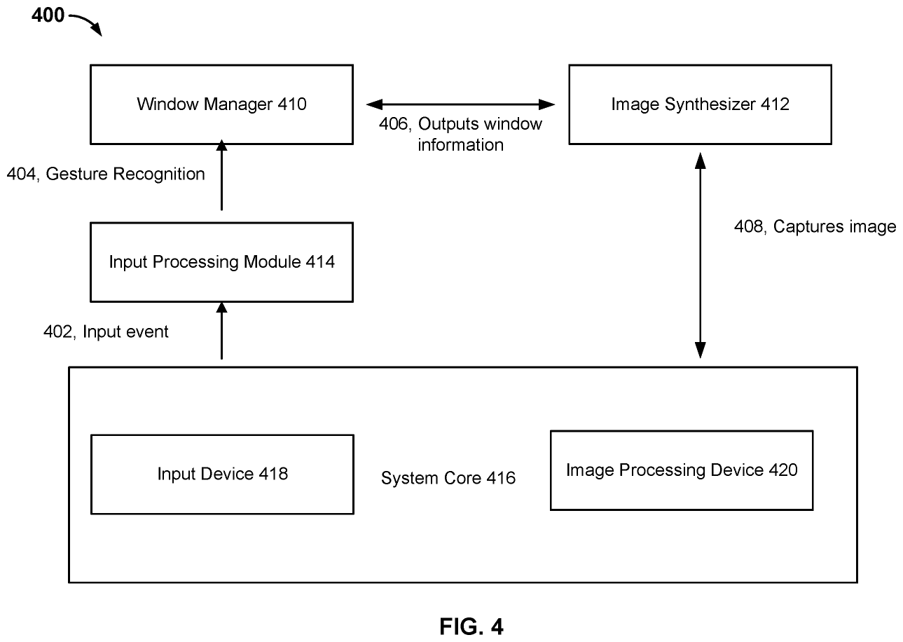

FIG. 4 is a diagram showing an embodiment of a system for efficient image sharing. FIG. 4 shows an example terminal device, terminal device 400. Terminal device 400 includes system core 416, which includes input device 418 and image processing device 420. Input device 418 is configured to detect an input. Image processing device 420 (e.g., a graphics processing unit (GPU)) is configured to execute image-related processing. Terminal device 400 further includes (e.g., as part of the operating system) window manager 410, image synthesizer 412, and input processing module 414. Input processing module 414 is configured to process input events. Window manager 410 is configured to manage interface windows (e.g., positioning and instructing windows for capturing images). Image synthesizer 412 is configured to synthesize images.

The modules, sub-modules, and units described herein can be implemented as software components executing on one or more processors, as hardware such as programmable logic devices, and/or as Application Specific Integrated Circuits designed to elements that can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present disclosure. The modules, sub-modules, and units may be implemented on a single device or distributed across multiple devices.

As shown in the process that is also depicted in FIG. 4, at step 402, an input event may be detected by input device 418. The input event is then transmitted to input processing module 414. Then, in step 404, input processing module 414 is configured to recognize a gesture based on the input event and inputs the coordinates (e.g., topx, topy, width, height) of the area defined by the gesture to window manager 410. In step 406, window manager 410 is configured to determine window information and output, based on the gesture and the area, corresponding coordinate information related to the gesture to image synthesizer 412. For example, window manager 410 may determine a window that pertains to the gesture action, such as a currently running application interface window, and then outputs the layer identifier corresponding to this window and the coordinates of the layer capture area as window information to image synthesizer 412. In step 408, image synthesizer 412 is configured to transmit this window information to image processing device 420 for image processing device 420 to capture the image. After image processing device 420 captures the image, image processing device 420 is configured to send the image back to image synthesizer 412, which is configured to synthesize the image data. For example, an image of a designated area is read from image processing device 420 (e.g., a GPU) and provided as feedback to image synthesizer 412, which generates image data with the corresponding formatting. It is also possible to send the image data back to window manager 410 for display or other processing.

Then, returning to FIG. 1, as for the image data classification information identified in step 104, the content in the image can be identified and then the classification information can be determined according to the content. For example, a classifier (e.g., a machine learning model) is trained to identify classification corresponding to image data. It is thus possible to use the classifier to identify classification information corresponding to the content that is contained in the image data. The classifier may also be referred to as “a classification model” or “data sets for classification.” The classifier is configured to identify the category of the content that is contained in an image. The classifier may be obtained from data model training. An image may be input into the classifier, and the classifier can output classification information for the image. This classification information may include one or more categories. The categories are associated with the content contained in the image data. For example, returning to the example of FIG. 2, the content included in the image data of circular area 208 may be classified into the categories of “clothing,” “upper garment,” and “T-shirt.”

In one example, the training for a classifier is based on an image database and a convolutional neural network (CNN) model. The image database may store image data acquired from terminal devices or the Internet and the classification information for the content contained in this stored image data. The CNN model then undergoes training using this stored image data to obtain the classifier. The trained classifier may then be used to identify the classification information of the content contained in the image.

In some embodiments, using the classifier to identify classification information corresponding to the content contained in the image data includes using the classifier to subject image data to classification processing, determining the classification result vector of the content contained in the image data, and treating the classification result vector as classification information. In some embodiments, a “classification result vector” comprises a data structure that includes a respective probability that the content of the image data is of each of one or more categories. For example, if there were ten possible categories to which the content of the image data could be classified, then the classification result vector would include 10 values, where each value would represent the probability that the image data should be classified under a corresponding category. In some embodiments, one or more such classification result vectors may be output by the classifier based on the input of image data. For example, if there are multiple classification result vectors that are output by the classifier, then the classification result vectors correspond to different hierarchies of categories within a hierarchy/tree of categories, where each value of a classification result vector would represent the probability that the image data should be classified under a corresponding category of a respective hierarchy level of categories.

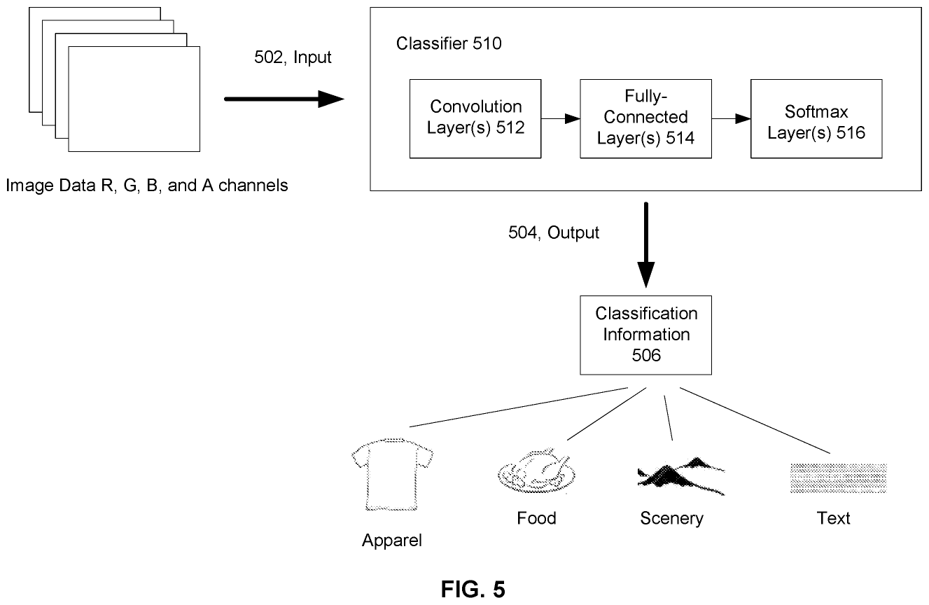

FIG. 5 is a diagram showing an example of a classifier in accordance with some embodiments. In some embodiments, step 104 of FIG. 1 may be implemented using classifier 510 that is described in FIG. 5. In the example of FIG. 5, data from four channels (R, G, B, A) can be extracted from input image data to serve as input into classifier 510. In the example of FIG. 5, R channel is the red space channel, G is the green space channel, B is the blue space channel, and A is the Alpha space, i.e., transparency/opacity, which serves as the opacity parameter. After the above R, G, B, and A channels of data are input into classifier 510 in step 502, the data can be processed by convolutional layer(s) 512, fully-connected layer(s) 514, and softmax layer(s) 516 in classifier 510. Softmax layer(s) 516 may be regarded as normalization layer(s). The data of the four channels described above are input into fully-connected layer(s) 514 after being processed by convolutional layer(s) 512, which are configured to identify features of the input image data. Fully-connected layer(s) 514 are then used to determine the probabilities and other data of each classification. The probabilities and other data of each classification are thereupon normalized with softmax layer(s) 516 into classification information 506 (e.g., classification result vectors). Different classification result probabilities may serve as a basis to generate corresponding classification result vectors. In some embodiments, the probabilities of various classification results are integrated into one classification result vector. In the example of FIG. 5, classification information 506 comprises the classification result vector(s). As shown in FIG. 5, specific example classification categories of classification information 506 that are output at step 504 by classifier 510 include apparel, food, scenery, and text. Thus, the classification result vector(s) of classification information 506 include probabilities associated with each respective category of image data.

In some embodiments, image data classification information is obtained from classifier processing. This classification information may be a level-one classification, or it may be a level-N classification, with N being a positive integer greater than 1. The specifics may be determined in accordance with actual need. In level-N classifications, for example, the level-one classification may refer to a category within a predetermined level (e.g., the highest level) of categories in a hierarchy or tree of categories. Then, each level-two classification may refer to a sub-category in a level below the level-one classification and so forth. Returning to FIG. 2, after the image data that is captured within circular area 208 of display screen 202 is input into a classifier such as classifier 510, the corresponding identification result could be “clothing” (a level-one classification), “upper garment” (a level-two classification, where “upper garment” is a sub-category of the “clothing” category), or “T-shirt” (a level-three classification, where “T-shirt” is a sub-category of the “upper garment” category). As for level-two through level-N classifications, they may be obtained through multiple processing by a network model comprising the convolutional layers, fully-connected layer, and softmax layer, similar to those that are described above. For example, the level-one classification information that is obtained from a single processing and the image data are input again into the network model to obtain classification information for level-two and/or level-N classifications. For example, a classification result vector is obtained through softmax layer processing. This classification result vector may be a level-one classification that includes, for example, the probability for the apparel level-one category, the scenery level-one category, the food level-one category, and the text level-one category. In a specific example, the classification result vector may be level-N classifications that include, for example, the probability of clothing and its categories, the probability of pants and their categories, the probability of jeans and their categories, . . . etc.

Thus, a classifier obtained through training may quickly determine classification information for image data. After the image data and its classification information are determined by the classifier and then used/confirmed by the user (e.g., which would confirm the appropriateness of the classification), the user confirmed image data and its classification information may serve as training data for subsequent optimization/retraining/updating of the classifier.

Returning to FIG. 1, after classification information is obtained for a given image data, at step 106, the classification information may serve as a basis to determine the corresponding sharing operation information. Put another way, the classification information may serve as a basis to determine sharing operation information for an image of the corresponding category. The sharing operation information is information relating to the publishing of the image data, such as the software program that is to be used for sharing the image data and type of operation that is to be used to execute the sharing. In various embodiments, the sharing operation information for the image data may be determined according to the analysis of the classification information by a data analyzer. In some embodiments, the data analyzer comprises a machine learning model or data sets for analysis. The data analyzer may be trained at least in part on the basis of users' historical use habit information. Classification information is thus input into the data analyzer for processing. The data analyzer can then output sharing operation information for the image data.

In some embodiments, using the data analyzer to analyze the classification information to determine the sharing operation information for the image data comprises obtaining user use habit information and converting the use habit information to use habit vectors, inputting the use habit vectors and classification result vectors into the data analyzer for analysis, and determining sharing operation information for the image data. Put another way, the sharing operation information for an image data may also be based on user habits. Therefore, users' historical use habit information may be collected in advance of training the data analyzer. In a first example, the users' historical use habit information may include the sharing programs executed by users after acquiring different images. In a second example, the users' historical use habit information could also include the types of sharing operations that were executed by users in different programs, e.g., searching for clothes in shopping programs, sharing selfies in instant messaging programs, and looking up travel location information in travel programs. These users' use habit information may also be converted into use habit vectors. For example, associations are established in use habit vectors between programs and the sharing operation information therein. Furthermore, a use habit vector is generated for the shared operation information according to the category. The category that is associated with the shared operation information in a use habit vector includes a probability of 1, and other categories that are not associated with the shared operation information in the vector include probabilities of 0. Thus, the category vector corresponding to the sharing operation information for each program serves as the use habit vector. Therefore, in some embodiments, use habit vector(s) and classification result vector(s) are input into the data analyzer. The data analyzer is configured to analyze the input sharing operation information for the image data.

In some embodiments, the data analyzer may be obtained on the basis of training with various analysis models. For example, the data analyzer may be trained using a multi-layer perceptron (MLP) model. As mentioned above, in some embodiments, sharing operation information includes at least “program information” and “operation information.” In some embodiments, “program information” is information that identifies the program that shares the image data, e.g., program ID and program name. In some embodiments, “information” is information on a particular type of sharing operation that is to be executed with regard to the image data, e.g., search, sending the image data to a chat contact, and other publishing operations. The operation information includes “sharing type” and/or “sharing content.” In some embodiments, “sharing type” is the type of page at which the image data is to be shared in the program, such as a search page, an information publishing page, or a chat page. In some embodiments, “sharing content” is the content corresponding to the image data, such as, for example, image ID and image storage address that are to be shared using the sharing operation type.

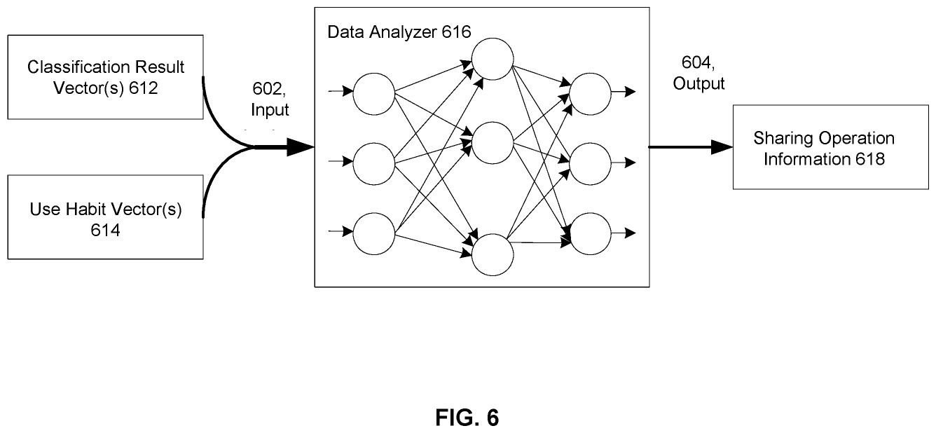

FIG. 6 is a diagram showing an example process of using a data analyzer in accordance with some embodiments. In some embodiments, step 106 of FIG. 1 may be implemented using data analyzer 616 that is described in FIG. 6. In the example of FIG. 6, data analyzer 616 is a machine learning model that is trained with an MLP model. In step 602, use habit vector(s) 614 and classification result vector(s) 612 (e.g., that have been output by a classifier such as classifier 510 of FIG. 5) are input into data analyzer 616. Then data analyzer 616 is configured to process use habit vector(s) 614 and classification result vector(s) 612 to output (at step 604) corresponding sharing operation information 618. For example, the format of sharing operation information 618 is {program, sharing type, sharing content}. For example, the “sharing content” of the sharing operation information is the image data or data that is derived from the image data (e.g., a modified version of the image data). For example, the modified version of the image data may be a version of the image data that is modified to conform to the publishing specifications or limitations (e.g., a maximum file size) of the program that has been identified by sharing operation information 618. Thus, it is possible based on the input to obtain one set of sharing operation information. A specific example of sharing operation information 618 is as follows: program {Taobao}, sharing type {search}, and sharing content {short skirt image}. Another example of sharing operation information 618 could be: program {AutoNavi}, sharing type {location}, sharing content {Mount Fuji}. Yet another example of sharing operation information 618 could be: program {WeChat}, sharing type {sending to Moments [circle of friends]}, sharing content {picture of roast duck}.

As described above, in some embodiments, a classifier may determine the classification information for input image data. In some embodiments, a data analyzer may output the sharing operation information for a given image data based at least in part on the classification information corresponding to the image data and the historical use habits of the user. In some embodiments, the classifier model and the data analyzer model may be obtained through separate training. In some embodiments, the classifier and the data analyzer may be combined into one data processor or split into other processors. Or another data processor, data processing set, and processing model may be used instead. Such mathematical models are scientific or engineering models that are built using mathematical language and methods of mathematical logic. A mathematical model is a kind of mathematical structure that is directed at the dependency relationships among the features or quantities of a system with reference to a certain thing and that is expressed in mathematical language in generalized or approximate form. Such a mathematical structure is a purely relational structure of a system that is depicted with the help of mathematical symbols. A mathematical model may be one or a set of algebraic equations, differential equations, difference equations, integral equations, or statistical equations or a combination thereof. The interrelationships or causal relationships among all the variables in a system are quantitatively or qualitatively described by these equations. In addition to mathematical models described by equations, there are models described by other mathematical tools, such as algebra, geometry, topology, and mathematical logic. What mathematical models describe are system behaviors and features and not the actual structure of a system.

In some embodiments, the historical use habit information of various users may be uploaded to a server so that the server can train a data analyzer based on the use habit information of those users. In some embodiments, the sharing operation information that is ultimately confirmed by users may also be added to the body of historical use habit information to update the data analyzer's training set and to increase the analyzer's accuracy through training.

Returning to FIG. 1, after the sharing operation information is obtained for the image data, at step 108, a program that corresponds to the image data is invoked based on the sharing operation information, and the program is used to publish the image data. The sharing operation information may serve as a basis for determining the program that needs to be invoked (e.g., called). Then the image data is published in this program. Examples of publishing image data include performing an image-based search (e.g., for products) in an image database using the image data, posting the image data to a group chat with a circle of friends in a chat application, and sending the image data directly to a friend (e.g., via a texting or chatting application).

While the examples of sharing operation information described above largely discuss the identification of one program and one corresponding sharing operation type with which to perform the sharing of the image data, in some embodiments, the sharing operation information may include one or more recommended programs and corresponding sharing operations types from which the user is to select a confirmed program and sharing operation type. Therefore, a user selection instruction is received with respect to one of the recommended programs and sharing operation types. Then, the image data is configured to be published at the selected program using the corresponding sharing operation type.

In some embodiments, the invoking/calling the program corresponding to the image data based on the sharing operation information and using the program to publish the image data comprises: launching the corresponding program based on the program information of the sharing operation information; loading the image data in the program based on the operation information; and publishing the image data according to a publish instruction. For example, the program ID or program name that is specified within the program information of the sharing operation information is used to determine the program that needs to be launched or if the program has already been launched but was executing in the background, the background program that is to be executed in the foreground. The image data is then loaded into the program based on the operation information of the sharing operation information. For example, if the operation information specifies to perform a search operation, then the image data is loaded into a search input box in a corresponding page in the program. Then the page with the loaded image data of the program is presented at the terminal device along with an interactive element (e.g., button) to confirm the publication of the image data with respect to the program and/or the platform (e.g., a social media platform or a messaging application) with which the program is associated. In some embodiments, the user is also able to edit the page of the program at which the image data was loaded. In response to the user selection of the interactive element to confirm the publication of the image data, the image data can be published according to the sharing operation. For example, if the sharing operation were to send the image data to a contact in a messaging application, then the user selection of the interactive element will cause the loaded image data to be sent to that contact on that messaging platform. In another example, if the sharing operation were to post the image data to a social media platform in a messaging application, then the user selection of the interactive element will cause the loaded image data to be posted to the user's account on the social media platform.

In some embodiments, loading the image data in the program based on the operation information comprises: starting the corresponding page in the program based on the sharing type and loading the image data in the page based on the sharing content. The page (e.g., search page, chat page, circle of friends page, or Weibo editing page) that is to be started in the program can be determined based on the sharing operation type. For example, if the sharing operation type is to perform a search, then the search page of the program can be opened. In another example, if the sharing operation type is to post the image data to a chat with a particular contact on a messaging application, then the page corresponding to that chat session can be opened. In yet another example, if the sharing operation type is to post the image data to a social media platform, then the page corresponding to the user's account at the social media platform (e.g., WeChat or Weibo) can be opened. As mentioned above, the image data is loaded into the page. The user may also edit the image data, such as, for example, by changing the size of the image data, adding a filter or other augmentation to the image data, or adding text to accompany the image data. After editing is completed, the user can cause the image data to be published at the page of the program by selecting the presented interactive element.

Returning to FIG. 2, the user becomes interested in an article of clothing (a T-shirt) while browsing display screen 202 of a terminal device. The user then performs a user (e.g., swipe) operation on the touchscreen of display screen 202 to define circular area 208 around the T-shirt to capture image data in defined circular area 208. Classification processing is performed on the image data to determine that the classification information is “clothing.” The classification information of “clothing” and historical user use habits (associated with the particular user) are then input into a data analyzer to determine that the image data's corresponding sharing operation information is {instant messaging program Program A, sending to circle of friends, clothing image}. Page 204 corresponding to the circle of friends in the instant messaging program (“Program A”) can then be launched/started/executed in the foreground at the terminal device. Then the clothing image data is loaded into page 204. The corresponding loaded image data can be edited by the user in this page. After the user edits the image data (e.g., inputs some accompanying text), the user can select Publish button 210 to cause the image data (the image of the T-shirt) to be shared to his or her user's sharing page with his or her circle of friends at the instant messaging program, Program A.

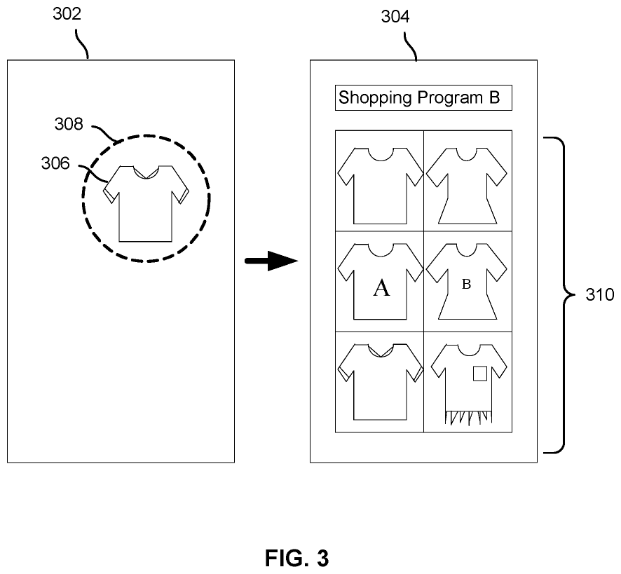

FIG. 3 is a diagram showing another example of efficient image sharing at a terminal device in accordance with some embodiments. For example, in display screen 302 of FIG. 3, a tap location of a user tap operation may be received with respect to shirt image 306. In response to the user tap operation, the tap location may serve as the center of circular area 308. In the example of FIG. 3, circular area 308 is determined by sweeping a predetermined radius from shirt image 306, which is associated with the tap location. Then, the image data within circular area 308 is captured as a screen image. In another example, circular area 308 is drawn by a user using a swipe operation and the coordinates of circular area 308 are determined based on the swipe coordinates. Then, the image data within circular area 308 is captured as a screen image. The swipe area may be of an irregular shape, and, in some embodiments, the swipe area may then be adjusted to the corresponding area that is of a regular circular, square, triangular, or some other shape. The image data within the adjusted regular shape is therefore captured. Classification processing is performed on the image data to determine that the classification information is “T-shirt.” The classification information of “T-shirt” and optionally, historical user use habit information are input into a data analyzer to determine multiple recommended sets of sharing operation information. In the example of FIG. 3, while not shown, different recommended sets of sharing operation information may be presented at the terminal device.

Some examples of the recommended sets of sharing operation information include: {instant messaging program, sending to circle of friends, T-shirt image}, {shopping program, search, T-shirt image}, {instant messaging program, sending to friend, T-shirt image}, etc. In the example of FIG. 3, the user selects (e.g., by tapping on the touchscreen) the sharing operation information where the image data of the “T-shirt” is input into a search function in Shopping Program B. As a result, Shopping Program B can be invoked at the terminal device and the corresponding search page of Shopping Program B is also presented at the terminal device (not shown in FIG. 3). The image data can be then loaded into the search page to conduct an image-based search or alternatively, a search based on the classification information of “T-shirt.” As a result of the search being performed in Shopping Program B, the resulting search results are shown in area 310 of display screen 304 of FIG. 3.

As mentioned above, content classification can be determined after the image is captured. For example, classification information for the content in the image is identified with a classifier. The classifier may be obtained by training with a CNN or other model, and it may enable smart classification of images on terminal devices. Moreover, in some embodiments, the user may also revise classification results by editing a particular selected sharing operation before confirming to publish the image data at a corresponding program. For example, if the image classification is “clothing,” the user may also add further detailed search information such as “T-shirt” before confirming the search to be performed in a shopping program. In some embodiments, the user edited (e.g., revision) information may also be uploaded to the server as training data for subsequent adjustment of the classifier and to increase the accuracy of classification.

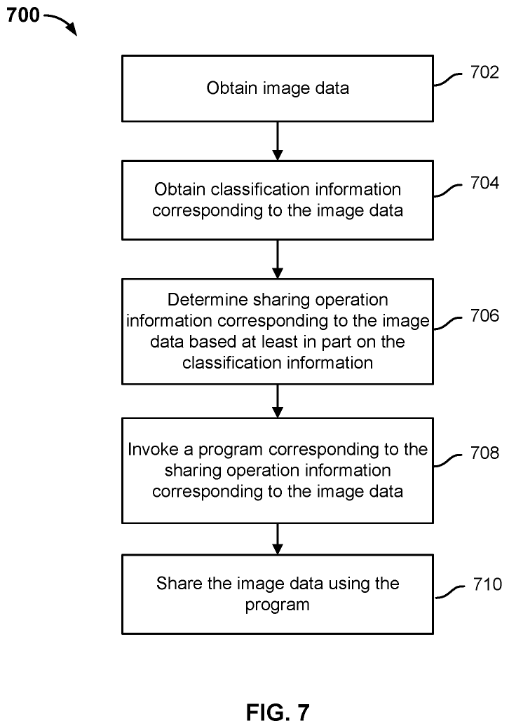

FIG. 7 is a diagram showing an embodiment of a process for efficient image sharing. In some embodiments, process 700 is implemented at terminal device 400 of FIG. 4.

At 702, image data is obtained.

There are various ways that a terminal device may acquire the image data that is to be shared. For example, the image data may be downloaded from the Internet, acquired locally (e.g., captured by taking a photo using the terminal device), downloaded from a program, or acquired by capturing a screen image.

In some embodiments, the user selects an interactive element (e.g., a button) or performs a predetermined gesture (e.g., a swipe operation around at least a portion of an image) with respect to the (e.g., touchscreen) of the terminal device to initiate the sharing of the obtained image data.

At 704, classification information corresponding to the image data is obtained.

At 706, sharing operation information corresponding to the image data is determined based at least in part on the classification information.

The obtained image data is input into a classifier. In some embodiments, the classifier comprises a model that has been trained to classify input data into various categories. In some embodiments, based on the image data as input, the classifier outputs one or more classification result vectors, where each classification result vector includes, for each potential category, a probability that the image data belongs to that category. For example, if the captured image data were an article of clothing, the corresponding classification result vector may include respective probabilities that the clothing is of the T-shirt, skirts, pants, or jackets category. In another example, if the captured image data were a photo of scenery, the corresponding classification result vector may include respective probabilities that the image is of the mountain, water, Guilin, Mount Fuji, or Lijiang category.

In some embodiments, to determine the corresponding sharing operation information for the image data, the classification result vector(s) that are determined based on the image data are input into a data analyzer. In some embodiments, in addition to the classification result vectors, one or more user historical use habit vectors pertaining to the particular user that had initiated the sharing operation or pertaining to multiple users are also input into the data analyzer. In some embodiments, the data analyzer comprises a model that has been trained to output an appropriate set of sharing operation information for a given set of classification information (e.g., classification result vectors) and historical user use habit vectors. In various embodiments, sharing operation information includes information that identifies the software program that is to be used for sharing the image data and type of operation that is to be used to execute the sharing. In some embodiments, the data analyzer is configured to output one or more sets of sharing operation information for a given set of classification result vector(s) and historical user use habit vectors. Where there are multiple sets of sharing operation information that are provided by the data analyzer, the sets of sharing operation information are presented at a user interface of the terminal device for the user to select one therein as the confirmed set of sharing operation information to execute.

At 708, a program corresponding to the sharing operation information corresponding to the image data is invoked.

The software program that is specified by the (e.g., user selected) sharing operation information is then invoked. If the program is not currently executing at the terminal device, the program is executed. If the program is already executing at the terminal device but in the background, the execution of the program is switched to the foreground. After the program is invoked, the page that corresponds to the type of sharing operation (e.g., searching at a shopping program, posting to a social media platform, sending to one or more contacts) is opened and the image data is loaded into the appropriate input location of the page.

At 710, the image data is shared using the program.

In various embodiments, the page of the program with the loaded image data comprises a user interface in which the user can make edits. For example, edits may include the addition of text, the modification/augmentation of the image data, and/or modifications to the type of sharing operation that is to be executed. In various embodiments, the page of the program with the loaded image data comprises a user interface that also includes an interactive element (e.g., a button) with which the user can select to confirm the publication/sharing of the (e.g., edited) image data through the program. In response to a user selection of the interactive element (e.g., a button) to confirm the publication/sharing of the (e.g., edited) image data, the image data is published using the program using the sharing operation type that is associated with the page.

For example, image data comprising clothing, T-shirts, short skirts, and other such items may be loaded into a page with a search function in a shopping program. In another example, data comprising clothing, T-shirts, skirts, and other such items may be sent to a friend in an instant messaging program in order to discuss whether they are worth buying. In yet another example, image data comprising scenery may be loaded into a page for sharing/posting to a social media platform in a social media platform program so that the image data can be shared with a circle of friends or a particular friend. In yet another example, image data comprising travel information relating to Guilin, Mount Fuji, or Lijiang may be loaded into a page with a search function in a travel-related program.

As mentioned above, image data that is to be shared is obtained and classification information corresponding to the image data can be determined. At least this classification information may be used to automatically determine a corresponding sharing operation information for the image data. Then, the image data may be published based on the sharing operation information. As such, the image data may be efficiently and intuitively shared.

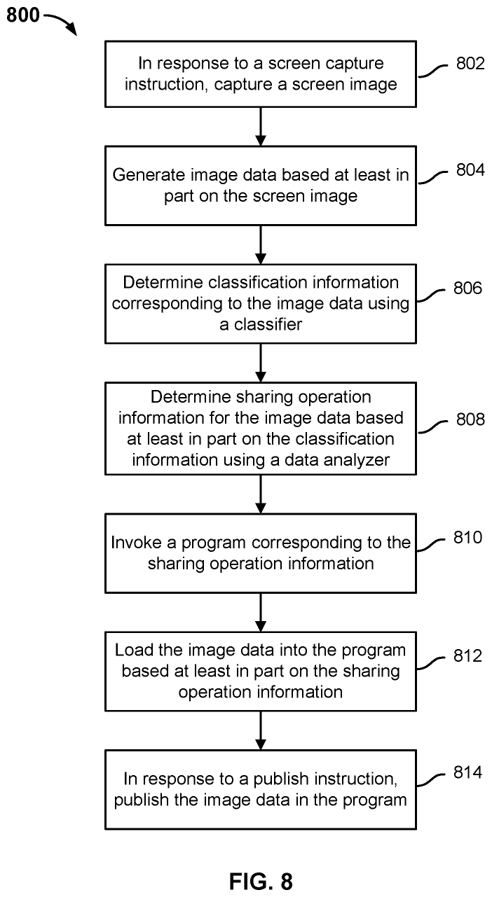

FIG. 8 is a diagram showing an example of a process for efficient image sharing in accordance with some embodiments. In some embodiments, process 800 is implemented at terminal device 400 of FIG. 4.

At 802, a screen image is captured in response to a screen capture instruction.

A user that is using a terminal device issues a screen capture instruction to the terminal device to cause the (e.g., operating system) of the terminal device to perform a screen capture on the content that is currently displayed at the display screen of the terminal device. For example, the screen capture instruction may be performed by tapping, swiping, or performing a gesture operation. The captured image is a screen image.

At 804, image data is generated based at least in part on the screen image.

The captured screen image may then be presented at a user interface of the terminal device. The user may define a capture area using a user operation on at least a portion of the screen image. The defined capture area is stored locally at the terminal device as the image data. For example, a round area on the screen image is determined based on a user tap location, and a round, triangular, square, or other polygonal area may be defined by the user using a swipe operation. The image content within the capture area is then determined as the “image data” for which sharing operation information is to be determined.

At 806, classification information corresponding to the image data is determined using a classifier.

The image data is input into a classifier, which is configured to perform classification processing on the image data. Thus, with the content contained in the image data, the classifier can determine a classification result vector for the corresponding content. The classification result vector may serve as classification information. Example categories of the classification information could, for example, be clothing, skirts, scenery, or Guilin.

In some embodiments, classification result vectors may be determined according to the probabilities of each category to which the data image may belong. For example, if the classifier is trained to identify 100 classifications, the classifier may determine a probability for each category associated with the data image and thus generate a 100-dimensional vector, with each dimension in the vector corresponding to one category. The value of each dimension is the probability that the image data belongs to a respective category.

At 808, sharing operation information for the image data is determined based at least in part on the classification information using a data analyzer.

The classification information is then input into a data analyzer. In some embodiments, the data analyzer is configured to perform analysis processing on the input classification information of image data to generate a recommended sharing operation information for the image data. As mentioned above, the sharing operation information includes at least identifying information of a software program through which to share the image data as well as the type of sharing operation that is to be executed using the image data in that program. In some embodiments, in addition to the classification information of the image data, historical use habits of the user are also input into the data analyzer. For example, the data analyzer may determine: a searching operation type for image data of clothing in a shopping program, a looking up operation type for image data of scenery in a travel program, an editing operation type of image data of text in an office program, or a publishing animation operation type of image data in an instant messaging program.

At 810, a program corresponding to the sharing operation information is invoked.

At 812, the image data is loaded into the program based at least in part on the sharing operation information.

In some embodiments, the data analyzer may output multiple alternative sets of sharing operation information. For example, if the data analyzer outputs multiple alternative sets of sharing operation information, then different sets of sharing operation information may include different sharing operation types and/or different programs. The multiple alternative sets of sharing operation information may be presented at a user interface at the terminal device and the user may select one set of sharing operation information through which to share the image data. The program of the selected set of sharing operation information is then invoked based on the program information that is included in the selected set of sharing operation information. The page of the program that corresponds to the sharing operation type that is included in the selected set of sharing operation information is started and the image data is loaded into that page. The program that is to be invoked according to the selected set of sharing operation information may be identified by a program ID and program name. The page (e.g., search page, chat page, circle of friends page, or Weibo editing page) that is to be started in the program is determined based on the sharing operation type. The page with the loaded image data is then presented at the user interface. The user may also edit the loaded image data (e.g., by adding text, modifying the image data, or changing the sharing operation type).

At 814, the image data is published in the program in response to a publish instruction.

The user interface that presents the loaded image data may also be presented with an interactive element that the user is to select to confirm the publication of the image data according to the sharing operation type, thereby completing the sharing of the image data.

In some embodiments, the functions described above (e.g., obtaining image data, classify the image data, and share the image data) may be implemented by an operating system of a terminal device. A user can share various kinds of information at any time as needed while operating the terminal device and thus conveniently and quickly implement sharing operations (e.g., search, publish, and location look up) with regard to image data that is obtained at the terminal device. For example, the corresponding function interfaces (e.g., application program interfaces, API) may be set in the operating system of the terminal device. As such, an instruction to share image data may be generated following a detection of a user performed gesture operation. The instruction then causes a corresponding function interface to be called. The function interface is configured to determine classification information and sharing operation information for the image data and use a program to ultimately publish the image data.

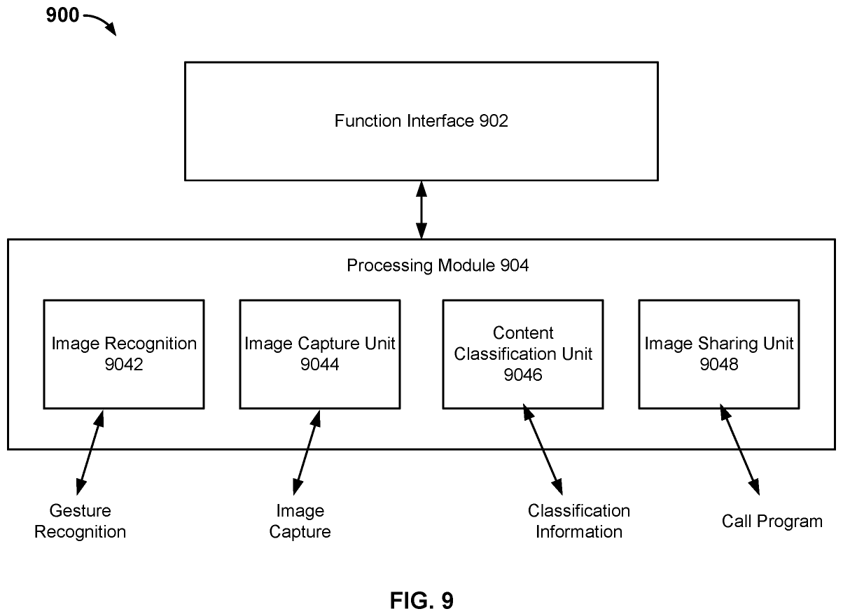

FIG. 9 is a diagram showing an example of an operating system for efficient image sharing in a terminal device. In the example of FIG. 9, operating system 900 includes function interface 902 and processing module 904. Function interface 902 may include various interfaces, such as a gesture recognition interface, an image capture interface, an image recognition interface, and an interface calling the program needed for sharing (not shown). Processing module 904 is built from corresponding processing logics. Processing module 904 may include image recognition unit 9042, image capture unit 9044, content classification unit 9046, and image sharing unit 9048. With regard to tap, swipe, or other user operations, image recognition unit 9042 may recognize a gesture information about a window area resulting from the gesture action based on a window manager. The gesture information is then input into image capture unit 9044. Image capture unit 9044 may call a GPU or other device to process the image of the corresponding window area captured by the device and generate image data based on an image synthesizer. The image data can then be input into content classification unit 9046, which comprises a classifier that is configured to produce corresponding classification information. The classification information is then input into image sharing unit 9048. Image sharing unit 9048 combines this classification information with the user's use habits to determine sharing operation information to share the image data using an application manager. In various embodiments, machine learning is used on content classifications and user use habits to learn user needs regarding content sharing and thus to provide smart and convenient user experiences.

Therefore, in some embodiments, a screen image of content displayed by a display screen of a terminal device may be captured by a gesture on the basis of functions provided by the above modules. The sharing operation information is determined through processing such as classification processing and sharing operation analysis. The sharing operation information may be presented as a list of sharing operation choices to a user, e.g., classification information identified from an image of Tianmu Mountain and the programs that are determined, including an instant messaging program, a travel program, and a map program, to use to share the image of Tianmu Mountain. A selection instruction may then be received from the user and used to determine activation of a travel program, which automatically searches for travel product information for the “Tianmu Mountain” content corresponding to the image.

Moreover, the above selection of a particular set of sharing operation information that is made by the user in addition to other use habit information may be provided as feedback to the system, which automatically learns the user's behavior based on the use habit information. These collected pieces of historical use habit information are used to train the classifier and the data analyzer. Thus, following multiple rounds of learning, when the user next shares similar content, (e.g., the classification information for the content corresponding to image data being classified as “Huangshan” or “Scenic Area”), the system performs processing to obtain the sharing operation information and then may automatically start the travel program to search for “Huangshan” or “Scenic Area” content corresponding to the image data. The obtained travel product information in the travel program can then be presented to the user at a user interface. By collecting historical user use habits (e.g., the user's selected sharing operation information) and using such information to retrain/improve the classifier and data analyzer models, the resulting models will be able to better classify image data found by the user and to better recommend corresponding sharing operation information.

Please note that all the method embodiments have been presented as a series of a combination of actions in order to simplify description. However, persons skilled in the art should know that embodiments of the present application are not limited by the action sequences that are described, for some of the steps may make use of another sequence or be implemented simultaneously in accordance with embodiments of the present application. Secondly, persons skilled in the art should also know that the embodiments described in the specification are all preferred embodiments. The actions that they involve are not necessarily required by embodiments of the present application.

The present embodiment further provides a data processing means based on the embodiments described above that can be applied to terminal devices, servers, and other electronic devices.

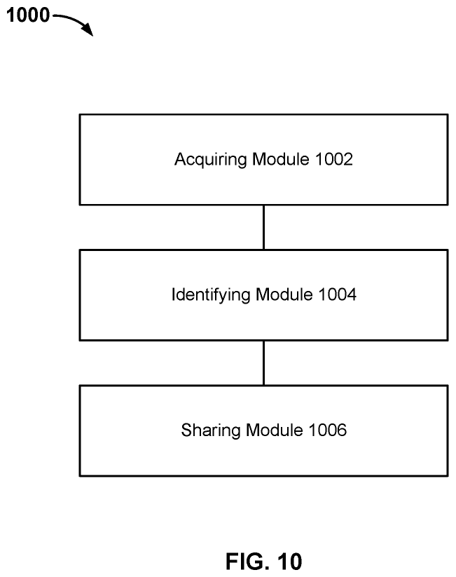

FIG. 10 is a diagram showing an example of a system for efficient image sharing in accordance with some embodiments. In the example of FIG. 10, system 1000 includes acquiring module 1002, identifying module 1004, and sharing module 1006.

Acquiring module 1002 is configured to obtain image data.

Identifying module 1004 is configured to identify the classification information for the image data and determine the corresponding sharing operation information based on the classification information.

Sharing module 1006 is configured to invoke the corresponding program based on the sharing operation information and use the program to publish the image data.

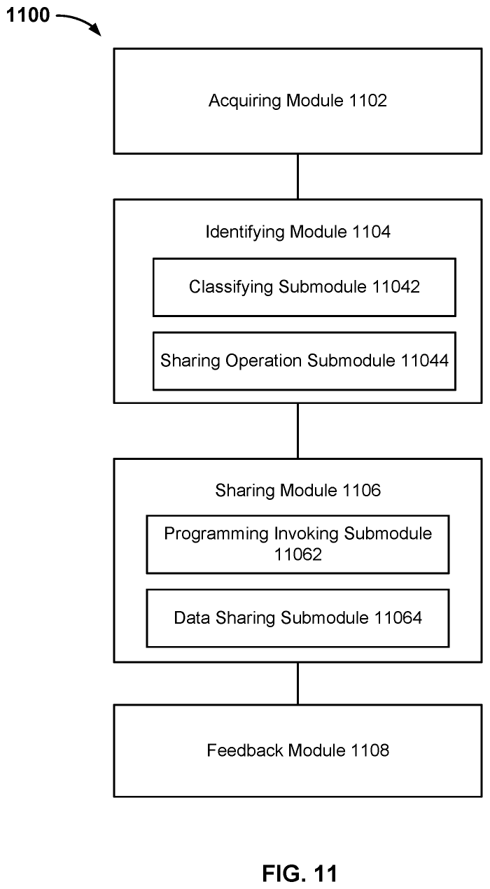

FIG. 11 is a diagram showing an example of a system for efficient image sharing in accordance with some embodiments. In the example of FIG. 11, system 1100 includes acquiring module 1102, identifying module 1104, sharing module 1106, and feedback module 1108.

Acquiring module 1102 is configured to acquire image data.

Identifying module 1104 is configured to identify the classification information for the image data and determine the corresponding sharing operation information based on the classification information.

Sharing module 1106 is configured to invoke the corresponding program based on the sharing operation information and use the program to publish the image data.

Feedback module 1108 is configured to collect the user selected and/or confirmed sharing operation information to use as a historical user use habit information that is to be used to retrain the classifier and data analyzer models.

Identifying module 1104 comprises classifying submodule 11042 and sharing operation submodule 11044.

Classifying submodule 11042 is configured to use the classifier to identify classification information corresponding to the content contained in image data.

Sharing operation submodule 11044 is configured to determine sharing operation information for the image data according to the analysis of the classification information by a data analyzer.

Classifying submodule 11042 is configured to use the classifier to subject image data to classification processing, determine the classification result vector of the content contained in the image data, and treat the classification result vector as classification information.

Sharing operation submodule 11044 is configured to acquire use habit information and convert the use habit information to use habit vectors, input the use habit vectors and classification result vectors into a data analyzer for analysis, and determine sharing operation information for the image data.

In some embodiments, the sharing operation information comprises at least: program information and operation information. Sharing module 1106 comprises: program invoking submodule 11062 and data sharing submodule 11064, wherein:

Program invoking submodule 11062 is configured to invoke the corresponding program based on the program information and load the image data into the program based on the operation information.

Data sharing submodule 11064 is configured to publish the image data according to a publish instruction.

In some embodiments, the operation information includes sharing operation type and sharing content. Program invoking submodule 11062 is configured to start the corresponding page in the program based on the sharing operation type and load the image data into the page based on the image content.

Acquiring module 1102 is configured to capture a screen image according to instruction information and generate corresponding image data.

Acquiring module 1102 is configured to determine the capture area according to the instruction information and capture the screen image corresponding to the capture area. The instruction information is triggered according to at least one of the following user operations: tap operation, gesture operation, and swipe operation.

In some embodiments, one or more programs that, when executed, implement efficient image sharing are stored in a non-volatile readable storage medium. When the one or more modules are applied to a terminal device, the terminal device is enabled to execute instructions of all the process steps described herein.

Embodiments of the present application provide one or more machine-readable media on which is stored executable code; when the executable code is executed, the processor is caused to execute one or more of the data processing methods described herein. The electronic devices include terminal devices, servers (clusters), and any other computing device. In some embodiments, a “terminal device” refers to a device that has a terminal operating system. Such devices can support audio, video, data, and other functions. They include mobile terminals such as smart phones, tablets, and wearable devices. They might also be devices such as smart televisions or personal computers. Some examples of operating systems are AliOS, iOS, Android, and Windows.

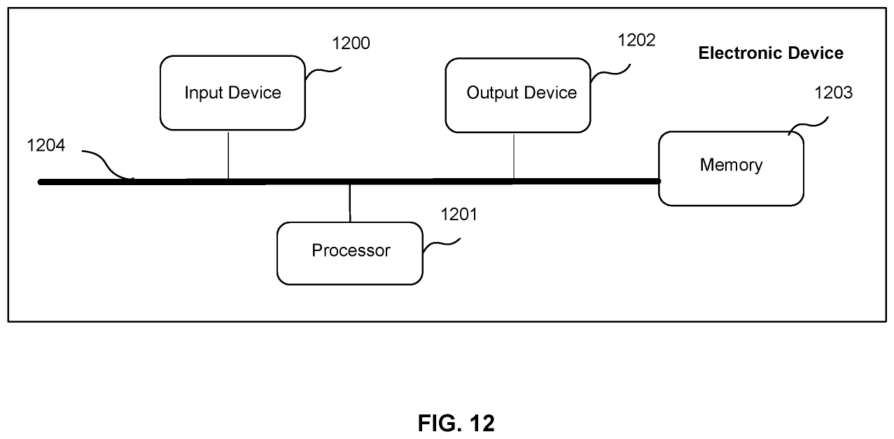

FIG. 12 is a hardware structural diagram of an electronic device in accordance with some embodiments. Examples of an electronic device may include a terminal device, a server (a cluster server), or another type of device. As shown in FIG. 12, the electronic device may comprise input device 1200, processor 1201, output device 1202, memory 1203, and at least communication bus 1204. Communication bus 1204 is configured to implement inter-component communication connections. Memory 1203 may contain high-speed RAM (Random Access Memory). Memory 1203 may also contain NVM (Non-Volatile Memory), such as at least one magnetic disk storage device. Memory 1203 may store various programs used to complete various processing functions and to implement the method steps described herein.

Optionally, processor 1201 could be implemented as a central processing unit (CPU), an application-specific integrated circuit (ASIC), a digital signal processor (DSP), a digital signal processing device (DSPD), a programmable logic device (PLD), a field-programmable gate array (FPGA), a controller, a microcontroller, a microprocessor, or another electronic component. Processor 1201 is coupled to the aforementioned input device 1200 and output device 1202 through a wired or wireless connection.

Optionally, input device 1200 may comprise multiple input devices. For example, input device 1200 could comprise at least one of the following: a user-oriented user interface, a device-oriented device interface, a software programmable interface, a camera, and a sensor. Optionally, the device-oriented device interface may be a wired interface for conducting device-to-device data transmissions, or it could be a hardware insertion interface (e.g., a USB interface or a serial port) for conducting device-to-device data transmissions. Optionally, the user-oriented user interface could, for example, be user-oriented control keys, a speech input device for receiving speech input, or a touchscreen perceiving device (such as a touchscreen or a touch tablet having touch-sensing functions). Optionally, the programmable interface of the software described above could be a portal, such as a chip input pin interface or output interface, through which the user edits or modifies the program. Optionally, the transceiver described above could be a radio-frequency transceiver chip, a baseband chip, or a transceiver antenna. A microphone or other audio input device can receive speech data. Output device 1202 may include a display device, sound equipment, and other output devices.

In some embodiments, processor 1201 of the electronic device comprises functions for executing all modules in the network management means in each electronic device. For specific functions and technical results, refer to the embodiments described above.

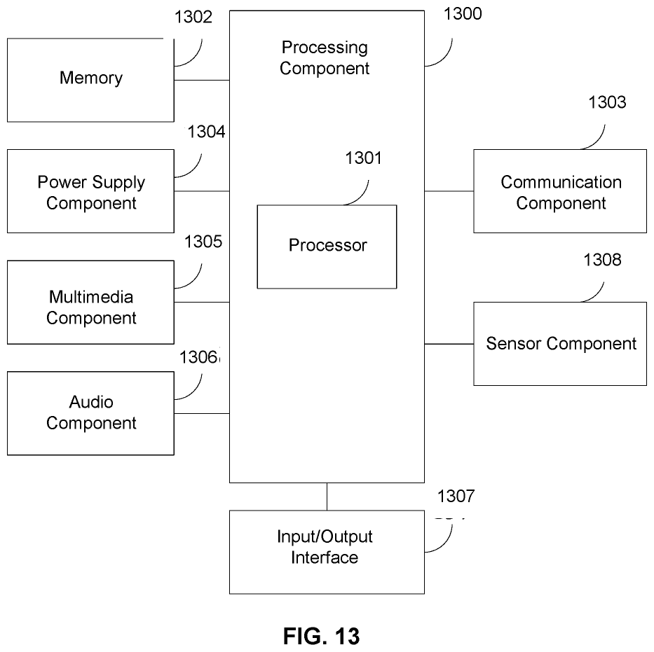

FIG. 13 is a hardware structural diagram of an electronic device in accordance with some embodiments. FIG. 13 is a specific embodiment in the implementation process relating to FIG. 12. As shown in FIG. 13, the electronic device includes processor 1301 and memory 1302.

Processor 1301 executes the computer code stored in memory 1302 and thus implements the data-processing methods of FIGS. 1 through 9.

Memory 1302 is configured to store all kinds of data in support of electronic device operations. Examples of this data include any app or method instructions, such as messages, pictures, and video, used for operations on the electronic device. Memory 1302 may contain random access memory (RAM) and may also contain non-volatile memory (NVM), such as at least one magnetic disk storage device.

Optionally, processor 1301 is set up in processing component 1300. The electronic device may further comprise: communication component 1303, power supply component 1304, multimedia component 1305, audio component 1306, input/output interface 1307, and/or sensor component 1308. The components specifically contained within the device are set according to need. The present embodiment imposes no limitations with regard to them.

Processing component 1300 generally controls the overall operations of the device. Processing component 1300 can comprise one or more processors 1301 for executing instructions so as to complete all or some of the steps of the method described above with regard to FIGS. 1 through 9. In addition, processing component 1300 may comprise one or more modules to facilitate interaction between processing component 1300 and other components. For example, processing component 1300 may comprise a multimedia module to facilitate interaction between multimedia component 1305 and processing component 1300.

Power supply component 1304 provides electric power to the various components of the device. Power supply component 1304 may include a power supply management system, one or more power supplies, and other components related to generating, managing, and allocating power to the electronic device.

Multimedia component 1305 includes an output interface display screen provided between the device and the user. In some embodiments, the display screen may comprise a liquid crystal display (LCD) or a touch panel (TP). If the display screen comprises a touch panel, the display screen may be implemented as a touchscreen to receive input signals from the user. The touch panel comprises one or more touch sensors to detect touch, swipe actions, and gestures on the touch panel. The touch sensor not only can detect the boundaries of touch or swipe actions, but also can measure the duration and pressure related to the touch or swipe operations.

Audio component 1306 is configured to output and/or input audio signals. For example, audio component 1306 includes a microphone (MIC). When the device is in an operating mode, e.g., speech recognition mode, the microphone is configured to receive external audio signals. The received audio signals can be further stored in memory 1302 or sent by communication component 1303. In some embodiments, audio component 1306 further comprises a speaker for output of audio signals.

Input/output interface 1307 provides an interface between processing component 1300 and peripheral interface modules. The peripheral interface modules may be click wheels, buttons, etc. These buttons may include but are not limited to: volume button, start button, and lock button.

Sensor component 1308 comprises one or more sensors and is used to provide status evaluations of various aspects of the device. For example, sensor component 1308 may detect the on/off status of the device, the relative position of the component, and the presence or absence of contact between the user and the device. Sensor component 1308 may include a near sensor that is configured to detect the presence of a nearby object when there is no physical contact, including measurement of distance between the user and the device. In some embodiments, sensor component 1308 may further comprise a camera.

Communication component 1303 is configured to facilitate wired or wireless communication between the electronic device and other electronic devices. The electronic device may access wireless networks based on a communications standard such as WiFi, 2G, 3G, or combinations thereof. In an embodiment, the electronic device may include a SIM card slot. The SIM card slot is for inserting a SIM card, which enables the device to register with a GPRS network and establish communication between the Internet and servers.

It is clear from the above that communication component 1303, audio component 1306, input/output interface 1307, and sensor component 1308 that relate to the example electronic device of the FIG. 13 embodiment may serve as an implementation of the input device in the example electronic device of FIG. 12.

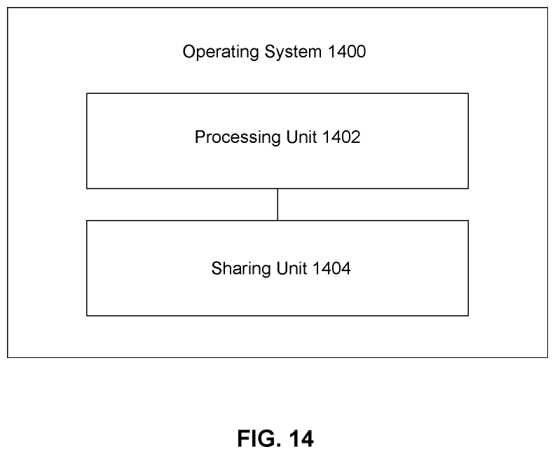

FIG. 14 is an example operating system that is executing at a terminal device in accordance with some embodiments. As shown in FIG. 14, terminal device operating system 1400 comprises processing unit 1402 and sharing unit 1404.

Processing unit 1402 is configured to acquire image data, identify the classification information for the image data, and determine the corresponding sharing operation information based on the classification information.

Sharing unit 1404 is configured to invoke the corresponding program based on the sharing operation information and use the program to publish the image data.

Each of the embodiments contained in this specification is described in a progressive manner. The explanation of each embodiment focuses on areas of difference from the other embodiments, and the descriptions thereof may be mutually referenced regarding portions of each embodiment that are identical or similar.

A person skilled in the art should understand that an embodiment of the present application may provide methods, means, or computer program products. Therefore, the embodiments of the present application may take the form of embodiments that are entirely hardware, embodiments that are entirely software, and embodiments that combine hardware and software aspects. Moreover, an embodiment of the present application may take the form of one or more computer program products implemented on computer-usable storage media (including but not limited to magnetic disk memory, CD-ROM, and optical memory) containing computer-usable program code.

The embodiments of the present application are described with reference to flowcharts and/or block diagrams based on methods, terminal devices (systems), and computer program products of the embodiments of the present application. Please note that each process and/or block within the flowcharts and/or block diagrams and combinations of processes and/or blocks within the flowcharts and/or block diagrams can be implemented by computer instructions. These computer program instructions can be provided to the processors of general-purpose computers, specialized computers, embedded processor devices, or other programmable data-processing terminals to produce a machine. The instructions executed by the processors of the computers or other programmable data-processing terminal devices consequently give rise to means for implementing the functions specified in one or more processes in the flowcharts and/or one or more blocks in the block diagrams.

These computer program instructions can also be stored in computer-readable memory that can guide the computers or other programmable data-processing terminal equipment to operate in a specific manner. As a result, the instructions stored in the computer-readable memory give rise to products including instruction means. These instruction means implement the functions specified in one or more processes in the flowcharts and/or one or more blocks in the block diagrams.

These computer program instructions can also be loaded onto computers or other programmable data-processing terminal devices and made to execute a series of steps on the computers or other programmable data-processing terminal devices so as to give rise to computer-implemented processing. The instructions executed on the computers or other programmable data-processing terminal devices thereby provide the steps of the functions specified in one or more processes in the flowcharts and/or one or more blocks in the block diagrams.

Although preferred embodiments of the present application have already been described, persons skilled in the art can make other modifications or revisions to these embodiments once they grasp the basic creative concept. Therefore, the attached claims are to be interpreted as including the preferred embodiments as well as all modifications and revisions falling within the scope of the embodiments of the present application.

Lastly, it must also be explained that, in this document, relational terms such as “first” or “second” are used only to differentiate between one entity or operation and another entity or operation, without necessitating or implying that there is any such actual relationship or sequence between these entities or operations. Moreover, the term “comprise” or “contain” or any of their variants are to be taken in their non-exclusive sense. Thus, processes, methods, things, or terminal devices that comprise a series of elements not only comprise those elements, but also comprise other elements that have not been explicitly listed or elements that are intrinsic to such processes, methods, things, or terminal devices. In the absence of further limitations, elements that are limited by the phrase “comprises a(n) . . . ” do not exclude the existence of additional identical elements in processes, methods, things, or terminal devices that comprise the elements.

Detailed introductions were provided above to a data processing method, a data processing means, an electronic device, and a machine-readable medium provided by the present application. This document has applied specific examples to explain the principles and implementations of the present application. The above descriptions of the embodiments are only for the purpose of aiding the understanding of the methods and core concepts of the present application. A person with ordinary skill in the art will always be able to make modifications in keeping with the idea of the present application to specific embodiments and scopes of the application. The content of this specification should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
obtain image data;
obtain classification information corresponding to the image data;
determine sharing operation information corresponding to the image data based at least in part on the classification information;
invoke a program corresponding to the sharing operation information corresponding to the image data; and
share the image data using the program; and
one or more memories coupled to the one or more processors and configured to provide the one or more processors with instructions.

2. The system of claim 1, wherein to obtain the image data comprises to:
in response to a screen capture instruction, capture a screen image; and
is generate the image data based at least in part on the screen image.

3. The system of claim 2, wherein to generate the image data based at least in part on the screen image comprises:
present the screen image at a user interface;
receive a user definition of a capture area over the screen image at the user interface; and
determine the image data based at least in part on the capture area.

4. The system of claim 3, wherein the user definition of the capture area being supported by a user swipe operation over at least a portion of the screen image.

5. The system of claim 3, wherein the user definition of the capture area being supported by a user tap operation at a location on the screen image and wherein the image data is determined based at least in part on sweeping a predetermined radius from the user tap location.

6. The system of claim 1, wherein to obtain the classification information corresponding to the image data comprises to input the image data into a classifier, wherein the classifier comprises a model that is trained to output probabilities that the image data belongs to one or more categories.

7. The system of claim 1, wherein to determine the sharing operation information corresponding to the image data based at least in part on the classification information comprises to input the classification information into a data analyzer, wherein the data analyzer comprises a model that is trained to output one or more sets of sharing operation information, wherein the sharing operation information comprises a sharing operation type and identifying information associated with the program to invoke and use to perform the sharing operation type with respect to the image data.

8. The system of claim 7, wherein the one or more processors are further configured to input historical user use habit information into the data analyzer with the classification information.

9. The system of claim 7, wherein the one or more processors are further configured to:
start a page of the program, wherein the page corresponds to the sharing operation type; and
load the image data into the page.

10. The system of claim 9, wherein the one or more processors are configured to receive a is user submitted edit to the loaded image data.

11. The system of claim 1, wherein to share the image data using the program comprises to receive a user instruction to publish the image data in the program prior to sharing the image data using the program.

12. A method, comprising:
obtaining image data;
obtaining, using one or more processors, classification information corresponding to the image data;
determining sharing operation information corresponding to the image data based at least in part on the classification information;
invoking a program corresponding to the sharing operation information corresponding to the image data; and
sharing the image data using the program.

13. The method of claim 12, wherein obtaining the image data comprises:
in response to a screen capture instruction, capturing a screen image; and
generating the image data based at least in part on the screen image.

14. The method of claim 13, wherein generating the image data based at least in part on the screen image comprises:
presenting the screen image at a user interface;
receiving a user definition of a capture area over the screen image at the user interface; and
determining the image data based at least in part on the capture area.

15. The method of claim 14, wherein the user definition of the capture area being supported by a user swipe operation over at least a portion of the screen image.

16. The method of claim 14, wherein the user definition of the capture area being supported by a user tap operation at a location on the screen image and wherein the image data is determined based at least in part on sweeping a predetermined radius from the user tap location.

17. The method of claim 12, wherein obtaining the classification information corresponding to the image data comprises inputting the image data into a classifier, wherein the classifier comprises a model that is trained to output probabilities that the image data belongs to one or more categories.

18. The method of claim 12, wherein determining the sharing operation information corresponding to the image data based at least in part on the classification information comprises inputting the classification information into a data analyzer, wherein the data analyzer comprises a model that is trained to output one or more sets of sharing operation information, wherein the sharing operation information comprises a sharing operation type and identifying information associated with the program to invoke and use to perform the sharing operation type with respect to the image data.

19. The method of claim 18, further comprising inputting historical user use habit information into the data analyzer with the classification information.

20. A computer program product, the computer program product being embodied in a computer readable storage medium and comprising computer instructions for:
obtaining image data;
obtaining classification information corresponding to the image data;
determining sharing operation information corresponding to the image data based at least in part on the classification information;
invoking a program corresponding to the sharing operation information corresponding to the image data; and
sharing the image data using the program.
